(19) United States
(12) Patent Application Publication
(10) Pub. No.: US 2021/0169720 A1
(43) Pub. Date: Jun. 10, 2021

(54) BED BASE ELEVATION SYSTEM

(71) Applicant: Marta PEREZ MARTINEZ, MADRID (ES)

(72) Inventor: Jose Luis DIAZ-HELLIN NICOLAS, MADRID (ES)

(21) Appl. No.: 17/045,452

(22) PCT Filed: Apr. 18, 2018
(86) PCT No.: PCT/ES2018/070308

§ 371 Date: Oct. 5, 2020

(51) Int. Cl. A61G 7/012; A47C 19/04

(52) U.S. Cl. CPC A61G 7/012; A47C 19/045

(57) ABSTRACT

The system comprises two frame structures (1) and (2) articulated with each other at their sides, the articulations (3) thereof incorporating bearings and connected in a simple manner by pins (14) and end washers (15), such that it incorporates lower supporting means that are stable at one end and rolling at the other end, whereby the elevation and lowering are performed by moving the frame structure (2) with a piston (10) that is driven by a motor (11), such that the piston (10) is articulated at its free end with a cross member (13) of the frame structure (2) and the motor (11) is articulated with the cross member (5′) of the frame structure (1). The frame structures end at the top in supports articulated with brackets in the form of forks (7) on which the bed base to be raised or lowered rests. The profiles used have a quadrangular cross-section, thereby providing a simple structure that is easily assembled and consequently inexpensive, usable with any bed base.

### OBJECT OF THE INVENTION

The present invention relates to an elevation system for bed bases, the obvious purpose of which is to allow raising and/or lowering a bed base in order to place the mattress at the desired height in the bed in which it is used, simplifying the bed raising and lowering operations for persons with limited mobility, or in order to change the bed sheets.

A further object of the invention is to provide a system with a structure that is simple, inexpensive to make, reliable in its operation, and highly stable, and that can also be adapted to any type of bed, as well as permitting connecting or separating it from the beds in which it is used.

### BACKGROUND OF THE INVENTION

It is known that making a bed, that is, the removal and fitting of sheets, etc. in both domestic situations and in hospitals, assisted living facilities, hotels, and the like, requires constant bending over and straightening since most beds are at a low height.

Similarly, old persons or persons with impaired mobility struggle when getting up or lying down on the bed, in many cases requiring assistance.

Although lifting beds already exist, these are generally conceived for hospital use and comprise complex mechanisms that perform multiple functions, and therefore are very expensive and not applicable for household use.

Moreover, this type of lifting beds have a mechanism that forms part of the bed itself and that cannot be used in another bed.

### DESCRIPTION OF THE INVENTION

The main feature of bed base elevation system of the invention is that it can be used in any bed and can be made independent of same to be used in a different one, while also having a very simple structure with a very low manufacturing cost that people can afford for personal use, while it can also be used in hospitals, hotels, assisted living facilities, households, etc.

More specifically, the system of the invention consists of two frame structures forming rectangular frames, articulated with each other by the side members thereof, such that one of the cross members of each frame has means that allow supporting the base of the bed in which it is used. The assembly is therefore connected to the bed base by said two opposite cross members of each frame, while the ends corresponding to the other cross members constitute the support means for the assembly on the floor, in one case by cushioning blocks and in the other by wheels to allow displacement thereof.

The articulation between the two frames is established by ball bearings mounted between each frame, transversally linked through a pin stabilised by end washers, which greatly simplifies the assembly of the device.

Obviously, the raising and lowering the base on the bed in which it is used, and therefore the raising and/or lowering one of the ends of the two frames in order to lift the bed base that rests on same, is performed by a piston driven by a motor, said piston being articulated at one of its ends with cross members provided in one of the frames and the motor being articulated with the cross member of the other frame, such that these articulations consist of bearings and pins with end washers.

As can be seen, the structure as described is very simple as it is based on two simple bases articulated with each other in scissor form, with an actuation element based on a piston. This structural simplicity allows raising the base of a bed so that it will rest on the structure described, to perform the corresponding operations required as easily as possible, without effort and without having to bend over as in conventional cases.

With this structure the device of the invention can be easily installed and removed in any bed in a very simple manner.

Consequently, a structurally simple, effective, inexpensive and easy to use device is obtained.

### DESCRIPTION OF THE DRAWINGS

To complete the description made below and aid a better understanding of the features of the invention, according to a preferred example of embodiment thereof, the description is accompanied by a set of drawings that form an integral part of same and which, for purposes of illustration only and in a non-limiting sense, show the following:

FIG. 1.—Shows a general perspective view of a bed base elevation system in accordance with the object of the present invention.

FIG. 2.—Shows a side elevation view of the device of the previous figure, showing the two frames with a scissor-type articulation.

FIG. 3.—Shows a plan elevation view of the device of the previous figures.

FIG. 4.—Shows a perspective view of the articulation of the actuation piston for the cross member corresponding to one of the frames.

FIG. 5.—Shows a perspective view of a detail of the articulation of the previous figure.

FIG. 6.—Shows, finally, a side elevation view of the ball bearings used in the articulation means between the two frames.

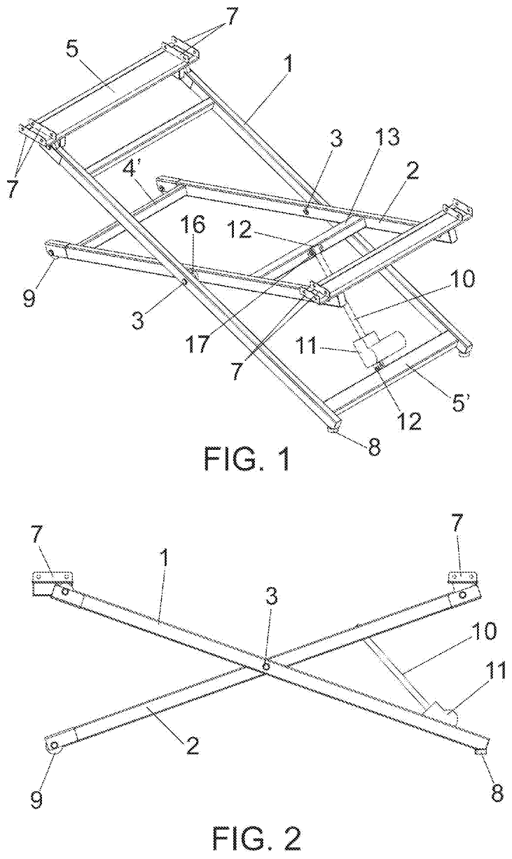

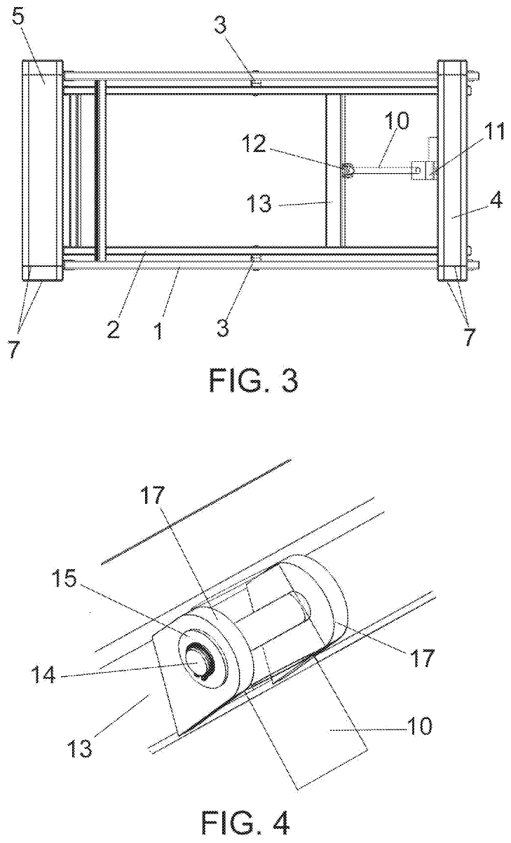

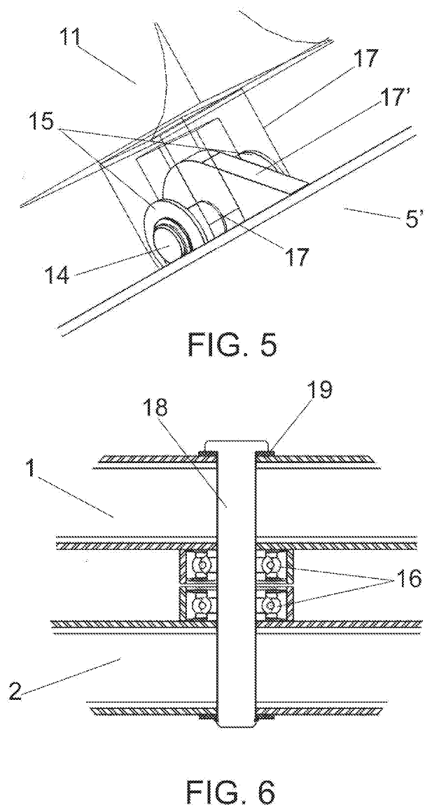

### PREFERRED EMBODIMENT OF THE INVENTION

In view of the aforementioned drawings, it can be seen that the system of the invention comprises two frame structures (1) and (2), each one defining a rectangular frame, such that the two frames are articulated in scissor fashion by an intermediate articulation (3), the ends of each frame having corresponding crossbars (4) and (5) articulated with said frame structures (1) and (2), and provided at their ends with pairs of brackets (7) in the form of forks on which the frame of the bed base will rest in a stable manner.

Said frames or structures (1) and (2) include, in correspondence with their lower end, corresponding cross members (4′) and (5′), said lower end of the frame structure (1) ending at a pair of support and immobilisation blocks (8), while the frame (2) includes wheels (9) at said lower end to absorb the horizontal level difference resulting when folding and unfolding the frame structure.

The extension and folding of the two frame structures (1) and (2) during the actuation for raising and/or lowering the bed base on which it is used, is performed by a piston (10) driven by a motor (11), such that the extensible arm of the piston (10) is linked through an articulation (12) to an intermediate cross member (13) of the second frame (2), while the other end, connected to the motor, is linked by a second articulation (12) to the lower cross member (5′) of the first frame structure (1), such that in both cases the articulations of the cylinder on the intermediate cross member (13) and of the motor on the cross member (5′) are established by pins (14) that pass through lugs (17-17′), stabilised by end washers (15), which substantially simplifies the assembly of the device.

In addition, the articulations (3) between the frame structures (1) and (2) are also established by bearings (16) disposed between the two frames, as shown in FIG. 6, and connected by a through pin (18) with end washers (19).

With this structure, the actuation of the motor (11) with the corresponding control, not shown in the figures and which can be wired or wireless, allows controlling the extension or retraction of the piston (10), the displacement of which controls the opening and closing of the scissor-like frame structure defined by the frame structures (1) and (2) so that the extension of said cylinder will lift the base that rests on the frame structure, while the retraction thereof will lower the base.

Lastly, it should be noted that the frame structures (1) and (2) are made from tubes with a rectangular cross-section, which substantially simplifies the manufacturing and assembly of the device.

As indicated above, the frame structure as described constitutes an element that can be easily used in any bed, due to its structural simplicity, and has a very low manufacturing cost so that it can be made accessible to a wide range of consumers.

1. Bed base elevation system, meant to be installed under any bed base to allow controlling the height thereof and consequently the height of the mattress resting on same, characterised by comprising two frame structures (1) and (2) that define corresponding rectangular frames with a scissor-type articulation at the central area of their side members, such that the upper end cross members (4) and (5) of said frame structures (1) and (2) are articulated with said frame structures (1) and (2) and have brackets in the form of forks (7) on top to receive the frame of the bed base that will be raised/lowered, establishing at the opposite ends of said frame structures (1) and (2) and in correspondence with the respective lower cross members (4′ and 5′) stable support means (8) and wheels (9) respectively, such that the frame structure (2) has a lower cross member (13), placing between said cross member and the lower cross member (5′) a piston (10) driven by a motor (11) connected by corresponding articulations (12) and actuated by the corresponding control.

2. Bed base elevation system, according to claim 1, characterised in that the articulation (12) of the motor (11) with the corresponding cross member (5′), as well as the articulation (12) of the cylinder (10) with the intermediate cross member (13), is established through pins (14) that pass through lugs (17) and are stabilised by end washers (15).

3. Bed base elevation system, according to claim 1, characterised in that the articulations (3) between the frame structures (1) and (2) are performed by bearings (16) and pins (14) stabilised by end washers (15).

4. Bed base elevation system, according to claim 1, characterised in that the frame structures (1) and (2) are made from tubes with a quadrangular cross-section.
